(19) United States
(12) Patent Application Publication
(10) Pub. No.: US 2016/0318740 A1
(43) Pub. Date: Nov. 3, 2016

(54) SYSTEM AND METHOD FOR MONITORING A WINCH

(71) Applicant: OPTION INDUSTRIES INC., Drayton Valley (CA)

(72) Inventors: Dustin KOS, Drayton Valley (CA); Tony WONG, Drayton Valley (CA); Marlin BELANGER, Drayton Valley (CA)

(73) Assignee: OPTION INDUSTRIES INC., Drayton Valley (CA)

(21) Appl. No.: 15/137,146

(22) Filed: Apr. 25, 2016

Related U.S. Application Data
(60) Provisional application No. 62/153,588, filed on Apr. 28, 2015.

(51) Int. Cl. B66D 1/54; G08B 3/06; G08B 7/06; B66D 1/48; G08B 5/22

(52) U.S. Cl. CPC B66D 1/54; B66D 1/485; G08B 5/22; G08B 7/06; G08B 3/06

(57) ABSTRACT

A system and method for monitoring and displaying operating conditions of a winch mechanism.

### FIELD OF THE INVENTION

The present invention relates to systems and methods for monitoring a winch system.

### BACKGROUND OF THE INVENTION

A conventional winch mechanism comprises a hydraulic motor in driving engagement with a gearbox that rotates a drum to wind or unwind a line attached to a load. The risk of line failure and its associated hazards may be controlled by taking precautions such as limiting the line tension, ensuring a minimum number of line windings around the drum, limiting the length of line extending from the drum, or limiting the age and load history of the line. Accordingly, there is a need in the art for a system that can monitor at least some of these operating conditions of the winch mechanism.

### SUMMARY OF THE INVENTION

In one aspect, the invention may comprise a system for monitoring a winch mechanism comprising a rotatable drum for winding or unwinding a line, and a motor for rotating the drum, the system comprising:
(a) a torque sensor configured to determine the drive torque of the motor;
(b) an encoder for monitoring rotation of the drum;
(c) a clock configured to measure an operating time of the winch;
(d) a computer comprising a processor and a memory, the processor operatively connected to the torque sensor, the encoder, and the clock, and the memory storing a set of instructions executable by the processor to perform a method comprising the steps of:
   (i) based on information from the torque sensor, the encoder, the real-time clock, or a combination of the foregoing, determining a value representative of one or more operating conditions of the winch; and
   (ii) causing an output device to display the one or more operating conditions in a human-readable format and/or notifying a user.
      In one embodiment, the motor is a hydraulic motor and the torque sensor comprises a first pressure transducer for measuring a hydraulic motor inlet pressure, and a second pressure transducer for measuring a hydraulic motor outlet pressure. In one embodiment, the one or more operating conditions may comprise: a motor drive torque; a line tension; a number of layers of line wound around the drum; a number of line windings around the drum; a line payout; and a line age. In one embodiment, if an operating condition exceeds a pre-determined value, the system may interrupt operation of the winch and/or provide a notification to a user.

In another aspect, the invention may comprise a method of monitoring a winch system comprising a motor and a winch drum, comprising the steps of:
(a) measuring information from one or more of a torque sensor configured to determine the drive torque of the motor, an encoder configured to monitor rotation of the drum; and a clock for measuring an operating time of the winch;
(b) continuously or periodically determining a value representative of one or more operating conditions of the winch comprising: a motor drive torque; a line tension; a number of layers of line wound around the drum; a number of line windings around the drum; a line payout; and a line age;
(c) continuously or periodically displaying data representative of the one or more operating conditions on an output device; and
(d) if the one or more operating conditions exceeds a pre-determined value, creating a notification or interrupting operation of the winch, or both.

### BRIEF DESCRIPTION OF THE DRAWINGS

The invention will now be described by way of an exemplary embodiment with reference to the accompanying simplified, diagrammatic, not-to-scale drawings. Any dimensions provided in the drawings are provided only for illustrative purposes, and do not limit the invention as defined by the claims. In the drawings:

FIG. 1 shows one embodiment of a graphical user interface displayed by the system of the present invention, for inputting and displaying the winch mechanism parameters.

FIG. 2 shows one embodiment of a graphical user interface displayed by the system of the present invention, for inputting and displaying the layer calculation parameters.

FIG. 3 shows one embodiment of a graphical user interface displayed by the system of the present invention, for displaying the line age, number of turns and payout of the winch mechanism.

FIG. 4 shows one embodiment of a graphical user interface displayed by the system of the present invention, for displaying the line pull and line tension of the winch mechanism.

FIG. 5 shows one embodiment of a graphical user interface displayed by the system of the present invention, for displaying a log of events in which the line tension of the winch mechanism has exceeded a prescribed threshold.

### DETAILED DESCRIPTION OF THE INVENTION

The present invention relates to systems and method for monitoring a winch mechanism.

A system of the present invention is for use with a winch mechanism comprising a rotatable drum for winding or unwinding a line, and a motor in driving engagement with the drum. The motor may comprise a hydraulic motor, an electric motor, or any other suitable motor. As known to persons skilled in the art, a hydraulic motor comprises a rotary device that rotates within a housing in response to a differential in hydraulic fluid pressure between a hydraulic fluid inlet and hydraulic fluid outlet of the motor. A hydraulic pump supplies hydraulic fluid under pressure to the hydraulic fluid inlet. The system and method described herein may be adapted to electric motor or other motor operation by those skilled in the art.

In one embodiment, the system of the present invention comprises a torque sensor for determining the drive torque of the motor, an encoder for measuring rotation of the drum, an input device, an output device, and a computer comprising a processor and a memory.

In one embodiment, where the motor is a hydraulic motor, the torque sensor comprises first and second pressure transducers to measure the pressure of the hydraulic fluid at the hydraulic fluid outlet and the hydraulic fluid inlet, respectively, of the hydraulic motor. The pressure transducers may comprise any suitable device known in the art that outputs an electronic signal indicative of the fluid pressure, which signal may be processed by the computer. The computer processes this information to determine the hydraulic motor drive torque and the line tension, as discussed below.

The encoder is configured to measure rotation of the drum, and may also measure angular position or velocity. The encoder may comprise any suitable device known in the art that outputs an electronic signal indicative of rotation of the drum, which signal may be processed by the computer. For example, the encoder may be an incremental rotary encoder which provides information about motion of the drum, or an absolute encoder which indicates current position of the drum. The encoder may sense motion or position of the drum itself, or may sense motion or position of a component which drives the drum. The computer may process this information to determine the rotational speed of the drum, the number of rotations of the drum which equates to the number of line turns around the drum, and the amount of line extending from the drum, as discussed below.

In one embodiment, the encoder comprises a rotary encoder which outputs a pulse string according to the rotation of the drum or a component which rotates the drum, such as a shaft.

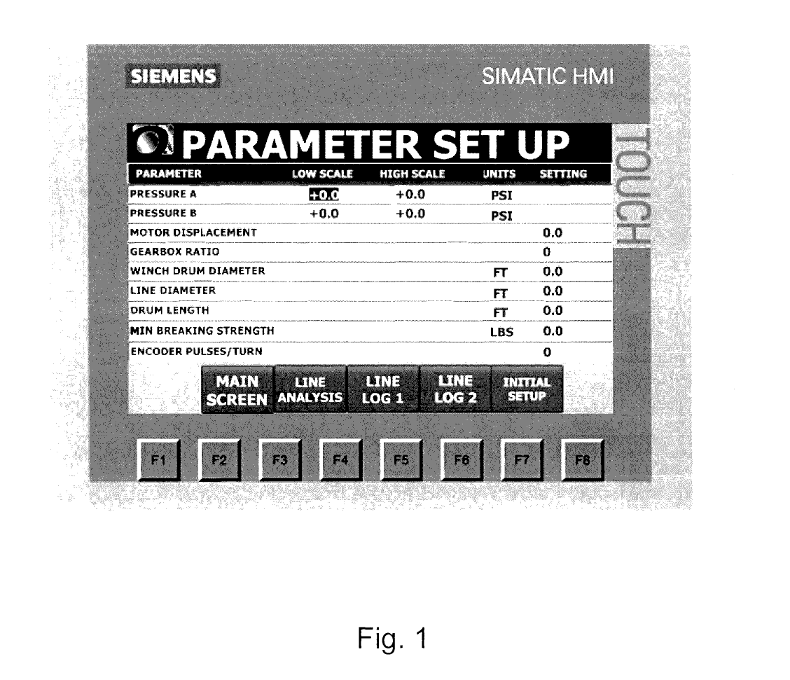

The input device allows an operator of the winch mechanism to provide information regarding the winch mechanism to the computer for storage in the computer memory. The input device may comprise, for example, a capacitive touch screen having a graphical user interface as shown in one embodiment in FIG. 1, which is operatively connected to the computer. The touch screen allows an operator to input information describing the winch mechanism including, without limitation, the tangential displacement of the hydraulic motor per revolution, the gearbox ratio, the diameter of the drum, the diameter of the line, the length of the drum, and the minimum breaking strength of the line, or any other relevant information. Accordingly, the system of the present invention may be customized by the operator for different winch mechanisms. In an alternative embodiment, the information describing the winch mechanism may already be stored in the memory of the computer, or is provided on a computer memory device readable by the processor. The input device may comprise a portable electronic device which communicates by wired or wireless means with the computer.

The output device may display information about the winch mechanism as determined by the computer in a format that can be sensed by a human operator. In one embodiment, the output device comprises a display (which may be the same capacitive touch screen as the input device) and, optionally, a speaker. By manipulating the input device, the operator can navigate amongst different graphical interfaces showing differing information associated with the winch mechanism, as shown in embodiments in FIGS. 1 through 5. In one embodiment, the output device is physically integrated with the input device, and is adapted for installation within a cab of a vehicle. The output device may comprise the same portable electronic device as the input device.

As is well known in the art, the input device and output device may be integrated as a component of a personal computer. The computer comprises a processor and a memory storing a software program, which comprises a set of instructions which may be executed by the processor. The processor is operatively connected to the pressure transducers, the rotary encoder, and the input device to receive signals for the information measured by these components, and if necessary, to store such information in the memory. The processor is also operatively connected to the output device to transmit signals encoding information determined by the processor or stored in the memory to the output device. The operative connections between the processor and these components may be wired or wireless radio connections.

The processor operates on the information acquired by the torque sensor (pressure transducers), the encoder, and the input device to determine one or more operating conditions associated with the winch mechanism.

In one embodiment, the processor determines the drive torque of a hydraulic motor of the winch mechanism, such as by using equation [1].

$$T = \frac{V \times Δ P \times R}{2 π} \qquad [ 1 ]$$

where:
T is the drive torque of the hydraulic motor;
V is the volumetric output per revolution of the hydraulic motor;
ΔP is the absolute value of the difference in hydraulic pressure measured by the first and second pressure transducers at the hydraulic fluid outlet and hydraulic fluid inlet, respectively, of the hydraulic motor; and
R is the gearbox ratio of the winch mechanism.

For example, the gearbox ratio may range from about 122 to about 206 (ie. 122 revolutions of the hydraulic motor causes a single rotation of the winch drum).

In one embodiment, the processor determines the line tension (L) of the winch mechanism, such as by using equation [2].

$$L = \frac{T}{0.5 \times {D}_{S} + 0.5 \times {D}_{L} + ( N - 1 ) \times {D}_{L}} \qquad [ 2 ]$$

where:
T is the drive torque of the hydraulic motor as determined by equation [1];
D_{S} is the diameter of the drum of the winch mechanism;
D_{L} is the diameter of the line of the winch mechanism; and
N is the number of layers of line wound around the drum of the winch mechanism.

For example, the drum diameter may range from about 8″ to 11″ and the line diameter may range from about 1″ to 1.5″.

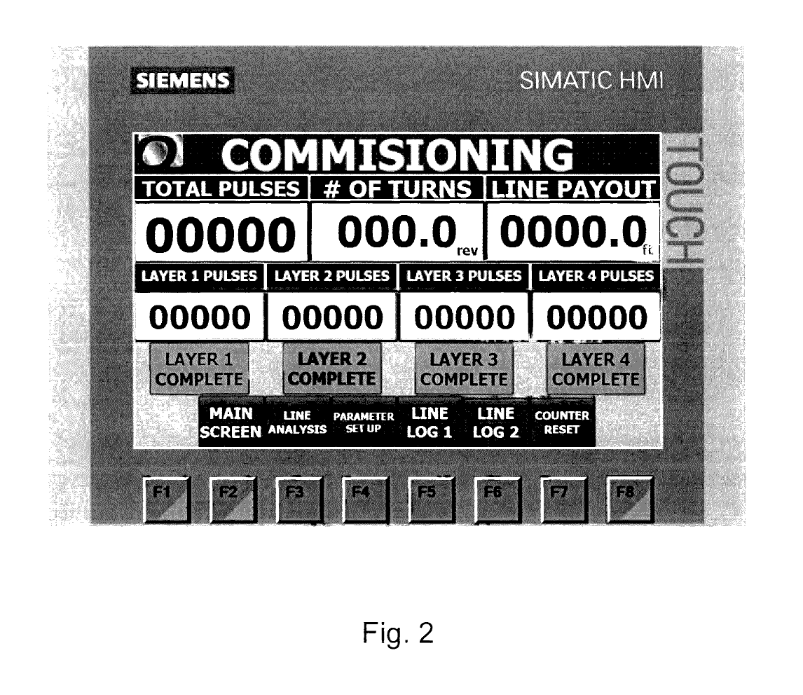

In the illustrated embodiment shown in FIG. 2, the processor prompts input from the user for calibration via the input device and, after calibration, the system can display the number of windings of line wound around the drum in real time via the output device.

As is known to those skilled in the art, when a line is wound on the drum of a winch, it is wound helically so that each rotation lays down line immediately adjacent line from the previous rotation. A single winding is one single rotation of the drum. This proceeds from one end of the drum to the other until a “layer” of line is complete. The line layering then continues in the opposite direction, until a second layer of line is helically wound around the first layer. Thus, if the number of windings per layer is known, and the circumference of the drum is known, the length of line per winding and per layer may be calculated. Of course, the effective circumference of the drum increases with each layer, as dictated by the diameter of the line.

For example, to calibrate the system, the total number of pulses on the encoder is reset to zero when the line is completely unloaded from the winch. The input device may provide a “Counter Reset” option which, when chosen, triggers the processor to reset the total number of pulses to zero. A pulse may be representative of one complete rotation of the drum, or a fraction of a complete rotation. After resetting the total number of pulses, the winch is loaded with line. When the line fully wraps around the drum once (the “first winding”), the user signals the processor to measure and record the number of pulses in the first winding. The user may signal the processor via the input device. For example, with reference to FIG. 2, when one full layer of line is wrapped around the drum, the user inputs to the system that “Layer 1 Complete” and a signal is sent to the processor. The winch is continued to be loaded with line, and when a second full layer of line wraps around the drum (the “second winding”), the user signals the processor to measure and record the number of pulses in the second winding, and so on. In one embodiment, the number of full layer wraps of the line (i.e. windings) around the drum does not exceed four.

In an alternative embodiment, the calibration steps may be automated using sensors which determine the completion of a single winding and the payout of the line.

Once calibrated, the processor may monitor and measure the number of pulses continuously, thereby allowing the output device to display the layer and/or the winding which the winch is on in real time in a graphical user interface displayed on the output device, as shown for example in FIG. 2.

In one embodiment, the processor determines the number of windings of the line—based on information provided by the rotary encoder. In one embodiment, the number of windings is determined in accordance with equation 3.

$$N = \frac{PU}{{PU}_{E}} \qquad [ 3 ]$$

where:
N is the number of windings of line wound around the drum of the winch mechanism;
PU is the number of pulses, as detected by the processor; and
PU_{E} is the number of pulses per revolution of the encoder.

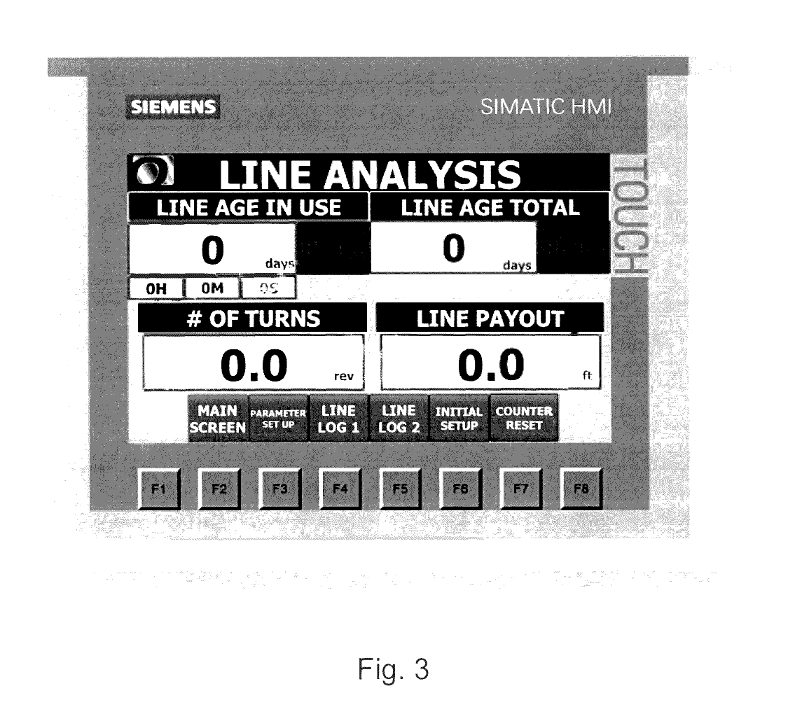

The processor may cause the output device to display a graphical user interface showing the number of windings (i.e. number of turns), as shown in one embodiment in FIG. 3.

As will be appreciated by persons skilled in the art of winch operation, it is generally recommended that a minimum number of windings be maintained when using the winch to pull in a load. Thus, in one embodiment, the processor causes the output device to provide a visual and/or audible alert to the operator if the processor detects that the number of windings is approaching or is at a pre-determined minimum number of windings.

In one embodiment, the processor determines the length of the line extending from the drum—i.e., the “line payout” —based on information provided by the rotary encoder. In one embodiment, the line payout, where the drum is on the first layer, may be determined in accordance with equation 4.

$${TLP}_{1} = \frac{π \times ( {D}_{S} + {D}_{L} ) \times PU}{{PU}_{E}} \qquad [ 4 ]$$

where:
TLP₁ is the total line payout where the current number of windings is 1;
D_{S} is the diameter of the drum of the winch mechanism;
D_{L} is the diameter of the line of the winch mechanism;
PU is the number of pulses, as detected by the processor; and
PU_{E} is the number of pulses per revolution of the encoder.

Where the drum is on a 2^{nd}, 3^{rd} or 4^{th} layer, the line payout may be determined with equation 5.

$${TLP}_{N} = {TLP}_{( N - 1 ) max} + \frac{π \times ( {D}_{S} + [ N + ( N - 1 ) ] \times {D}_{L} ) \times ( PU - {PU}_{N - 1} )}{{PU}_{E}} \qquad [ 5 ]$$

where:
TLP_{N} is the total line payout where the current number of windings is N;
N is the current number of layers;
TLP_{(N-1)max} is the maximum line payout of the previous layer, as determined by either equation 4 or 5, whichever is applicable.
D_{S} is the diameter of the drum of the winch mechanism;
D_{L} is the diameter of the line of the winch mechanism;
PU is the number of pulses, as detected by the processor;
PU_{N-1} is the measured pulses for the previous layer; and
PU_{E} is the number of pulses per revolution of the encoder.

The processor may cause the output device to display a graphical user interface showing the line payout in real time, as shown in one embodiment in FIG. 3.

As will be appreciated by persons skilled in the art of winch operation, it is generally recommended that the line payout is limited when using the winch to pull in a load. Thus, in one embodiment, the processor causes the output device to provide a visual or audible alert to the operator if the processor detects that the line payout is approaching or is at a pre-determined maximum line payout.

As will be appreciated by persons skilled in the art of winch operation, the line payout is significant to maintenance of the winch mechanism. The portion of the line within the line payout is unwound and re-wound during winching operations, and thereby exposed to wear. Further, the tension in the line tends to diminish from the portion of the line within the line payout towards the end of the line wound around the drum. Thus, in order to minimize the amount of the line that needs to be replaced due to wear and fatigue from prior loading, the operator may selectively cut off only that portion of the line within the determined line payout, rather than replace the line in its entirety.

In one embodiment, the processor determines the age of the line—i.e., the time during which the line is subjected to loading in use. In one embodiment, the computer comprises a real-time clock. The processor may cause the input device and output device to display a graphical user interface with a timer showing the line age in days, hours, minutes and seconds, as shown in one embodiment in FIG. 3. As an example, the timer may be started to register the line age when the system is first commissioned, and manually reset or automatically reset when the line is cut, so that the timer will again start to measure the line age from that time onwards.

In one embodiment, an operating condition may be adjusted according to a relative severity of winch duty. For example, the line age may be adjusted to account for load, as measured by line tension. For example, if the line has been used repeatedly in heavy load situations, the line age may be increased by a multiplier (for example, 1.2) which accounts for the heavy load. Conversely, if the line has been used only in light load situations, the line age may be decreased by a multiplier (for example, 0.9), which accounts for the light duty of the line during operation. The load multiplier may be readjusted after each usage.

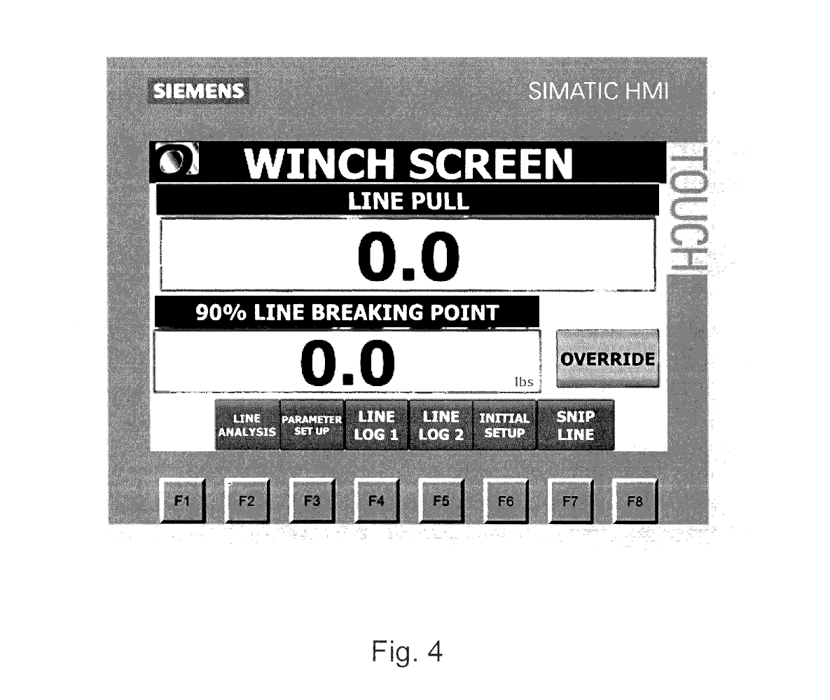

In one embodiment, the processor may cause the output device to display the determined line pull and the line tension in a graphical user interface, as shown in one embodiment in FIG. 4.

In one embodiment, the processor monitors the determined line tension and evaluates whether or not it exceeds a pre-determined threshold value. As a non-limiting example, the threshold value may be set to a multiple, such as 0.9 or 1.1 times, of the line's minimum breaking strength. If the processor detects that the determined line tension has exceeded the threshold value, then the processor may cause the output device to provide a visual or audible alert to the operator, or to interrupt rotation of the drum, such as by interrupting the hydraulic motor.

In one embodiment, the processor may monitor and store the usage history of the line of the winch mechanism, so as to define an envelope of operating conditions and an associated time history for the winch mechanism. For example, the processor may detect that the determined line tension has exceeded the threshold value, and in response thereto, store the determined line tension, number of turns, and line payout in association with a corresponding date and time stamp in the memory. In one embodiment, the recorded data may be transferred to a portable memory device, such as a USB flash drive or SD card, or transmitted to a user wirelessly, for example by using SMS or email capability.

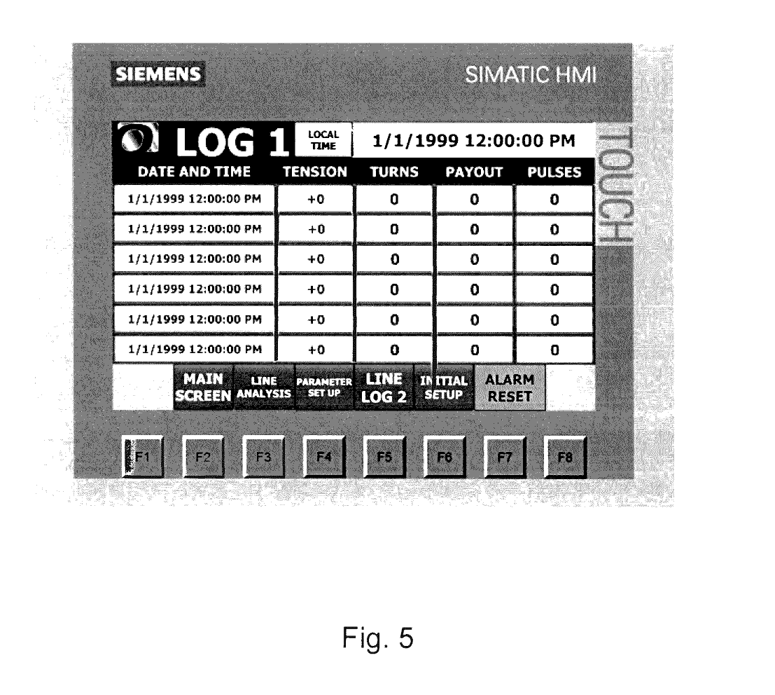

The processor may cause the output device to display a log of the usage history in a graphical user interface, as shown in one embodiment in FIG. 5. An operator can use the information in the log to assess whether the winch mechanism has been operated within desired limits, and to assess the length of the line that should be cut from the drum for maintenance purposes.

The terminology used herein is for the purpose of describing particular examples only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “another”, as used herein, is defined as at least a second or more. The terms “including” and “having,” as used herein, are defined as comprising (i.e., open language). The term “coupled,” as used herein, is defined as “connected,” although not necessarily directly, and not necessarily mechanically. “Operatively coupled” or “operatively connected” may refer to coupling of components such that these components are able to communicate with one another through, for example, wired, wireless or other communications media, and may also include, but is not limited to, communicating electronic control signals by which one element may direct or control another. The term “configured to” describes hardware, software or a combination of hardware and software that is adapted to, set up, arranged, built, composed, constructed, designed or that has any combination of these characteristics to carry out a given function. The term “adapted to” describes hardware, software or a combination of hardware and software that is capable of, able to accommodate, to make, or that is suitable to carry out a given function.

The terms “computer” or “processor” describe examples of a suitably configured processing system adapted to implement one or more examples herein. Any suitably configured processing system is similarly able to be used by examples herein, for example and not for limitation, a personal computer, a laptop computer, a tablet computer, a smart phone, a personal digital assistant, a workstation, or the like. A processing system may include one or more processing systems or processors. A processing system can be realized in a centralized fashion in one processing system or in a distributed fashion where different elements are spread across several interconnected processing systems.

The terms “computing system”, “computer system”, and “personal computing system”, describe a processing system that may include a user interface and which is suitably configured and adapted to implement one or more examples of the present disclosure,

The term “portable electronic device” is intended to broadly cover many different types of electronic devices that are portable or that can be transported between locations by a user. For example, and not for any limitation, a portable electronic device can include any one or a combination of the following: a wireless communication device, a laptop personal computer, a notebook computer, a desktop computer, a personal computer, a smart phone, a personal digital assistant, a tablet computer, gaming units, remote controller units, and other handheld electronic devices that can be carried on one's person.

The corresponding structures, materials, acts, and equivalents of all means or step plus function elements in the claims below are intended to include any structure, material, or act for performing the function in combination with other claimed elements as specifically claimed. The description herein has been presented for purposes of illustration and description, but is not intended to be exhaustive or limited to the examples in the form disclosed. Many modifications and variations will be apparent to those of ordinary skill in the art without departing from the scope and spirit of the examples presented or claimed. The disclosed examples were chosen and described in order to best explain the principles of the examples and the practical application, and to enable others of ordinary skill in the art to understand the various examples with various modifications as are suited to the particular use contemplated. It is intended that the appended claims below cover any and all such applications, modifications, and variations within the scope of the invention.

What is claimed is:

1. A system for monitoring a winch mechanism comprising a rotatable drum for winding or unwinding a line, and a motor for rotating the drum, the system comprising:
(a) a torque sensor configured to determine the drive torque of the motor;
(b) an encoder for monitoring rotation of the drum;
(c) a clock configured to measure an operating time of the winch mechanism;
(d) a computer comprising a processor and a memory, the processor operatively connected to the torque sensor, the encoder, and the clock, the memory storing a set of instructions executable by the processor to perform a method comprising the steps of:
(i) based on information from the torque sensor, the encoder, the real-time clock, or a combination of the foregoing, determining a value representative of one or more operating conditions of the winch; and
(ii) causing an output device to display the one or more operating conditions in a human-readable format and/or display or provide a notification.

2. The system of claim 1 wherein the motor is a hydraulic motor, and the torque sensor comprises a first pressure transducer for measuring a hydraulic motor inlet pressure, and a second pressure transducer for measuring a hydraulic motor outlet pressure.

3. The system of claim 1 wherein the method comprises the further step of storing the one or more determined operating conditions in association with a time stamp in the memory.

4. The system of claim 1 wherein the one or more operating conditions comprises one or more of a motor drive torque; a line tension; a number of layers of line wound around the drum; a number of line windings around the drum; a line payout; and a line age.

5. The system of claim 4 wherein the method further comprises the step of determining whether any one of the one or more determined operating conditions exceeds a pre-determined threshold value, and, in response thereto, either causing the output device to provide a visual or audible alert, and/or interrupting rotation of the drum.

6. The system of claim 4 wherein the one or more operating condition is adjusted according to a relative severity of winch duty.

7. A method of monitoring winch usage, in a winch system comprising a motor and a winch drum, comprising a winch drum, comprising the steps of:
(a) measuring information from one or more of a torque sensor configured to determine the drive torque of the motor, an encoder configured to monitor rotation of the drum; and a clock for measuring an operating time of the winch;
(b) continuously or periodically determining a value representative of one or more operating conditions of the winch comprising: a motor drive torque; a line tension; a number of layers of line wound around the drum; a number of line windings around the drum; a line payout; and a line age;
(c) continuously or periodically displaying data representative of the one or more operating conditions on an output device; and
(d) if the one or more operating conditions exceeds a pre-determined value, creating a notification and/or interrupting operation of the winch.

8. The method of claim 7 wherein the motor is a hydraulic motor and the torque sensor comprises a first pressure transducer for measuring a hydraulic motor inlet pressure, a second pressure transducer for measuring a hydraulic motor outlet pressure.

9. The method of claim 7 wherein the notification is a visible and/or audible alarm.

10. The method of claim 7 wherein the line age is cumulatively determined based on operating time of the winch, and a notification is created when the line age exceeds a pre-determined value.

11. The method of claim 7 wherein the value representative of at least one operating condition is adjusted according to a relative severity of winch duty.
